(19) United States
(12) Patent Application Publication
(10) Pub. No.: US 2025/0013962 A1
(43) Pub. Date: Jan. 9, 2025

(54) METHODS AND SYSTEMS FOR OPTIMIZING OPEN-PIT MINE PRODUCTION PLANS BASED ON TIME-SERIES PREDICTION OF COPPER PRICE

(71) Applicants: CHINA UNIVERSITY OF GEOSCIENCES, WUHAN, Wuhan (CN); GEOLOGY TEAM 103, BUREAU OF GEOLOGY AND MINERAL EXPLORATION AND DEVELOPMENT, GUIZHOU PROVINCE, Tongren (CN)

(72) Inventors: Xialin ZHANG, Wuhan (CN); Shaoyi XU, Wuhan (CN); Changhe LI, Wuhan (CN); Zhanglin LI, Wuhan (CN); Liangjun YUAN, Tongren (CN); Zhengping WENG, Wuhan (CN); Guorong CAI, Tongren (CN); Luyi ZHANG, Wuhan (CN); Hui LIU, Wuhan (CN); Xiang LI, Wuhan (CN)

(73) Assignees: CHINA UNIVERSITY OF GEOSCIENCES, WUHAN, Wuhan (CN); GEOLOGY TEAM 103, BUREAU OF GEOLOGY AND MINERAL EXPLORATION AND DEVELOPMENT, GUIZHOU PROVINCE, Tongren (CN)

(21) Appl. No.: 18/764,104

(22) Filed: Jul. 3, 2024

(30) Foreign Application Priority Data
Jul. 3, 2023 (CN) 202310805726.1

(51) Int. Cl. G06Q 10/0637; G06Q 30/0283; G06Q 50/02

(52) U.S. Cl. CPC G06Q 10/06375; G06Q 30/0283; G06Q 50/02

(57) ABSTRACT

Disclosed is a method for optimizing an open-pit mine production plan based on time-series prediction of copper price. The method includes collecting historical copper price based on dates, generating a processed multi-factor dataset using linear normalization and linear interpolation manners, and generating a correlation matrix, focusing on the correlation matrix using a Graph Convolutional Network (GCN) model, and decomposing a trend item sequence and a seasonal item sequence through Autoformer mechanism, predicting copper price through a time-series prediction model, and importing copper price as parameters into a production plan mathematical model to generating the production plan. The present disclosure is capable of focusing on the correlation between different factors in a multi-factor dataset including historical price information, effectively improving the accuracy of copper price prediction, and obtaining solutions with a higher accuracy and better fit for an actual production situation.

### CROSS-REFERENCE TO RELATED APPLICATIONS

This application claims priority to Chinese Application No. 202310805726.1, filed on Jul. 3, 2023, the entire contents of which are incorporated herein by reference.

### TECHNICAL FIELD

The present disclosure relates to the field of optimization of open-pit mine production plans, and in particular, to a method for optimizing the open-pit mine production plan based on time-series prediction of copper price.

### BACKGROUND

Long-term production plan of open-pit mines refers to rational planning of the mining sequence of ore and rock during each mining period, i.e., decision-making of the mining sequence and mining time of each ore body located at different geographical coordinates, so as to rationally arrange the mining throughout an entire mining life cycle to maximize profits. The rationality of open-pit mining planning is closely related to the profits of the mine. Therefore, in the process of open-pit mining, it is not only necessary to reasonably apply modern automation equipment and develop new processes, but also to reasonably plan and schedule the mining process, so as to maximize profits for mining enterprise. For intelligent optimization of the production plan, considering the time factor, it is necessary to determine the mining sequence of the ore rock according to economic data and engineering feasibility, to obtain the maximum possible net income. For large open-pit mines, the mathematical model contains a large number of variables due to a large number of blocks in their value model, making its calculation very difficult.

Therefore, it is desirable to provide a production plan optimization method that can take into account copper price affected by different factors, effectively improve the accuracy of copper price prediction, and obtain a production plan more in line with the actual production situation.

### SUMMARY

One or more embodiments of the present disclosure provide a method for optimizing an open-pit mine production plan based on time-series prediction of copper price. The method may be executed by a processor. The method may comprise: obtaining a raw dataset, including: obtaining a dataset of historical copper price and a dataset of other relevant factors correlating with the copper price, the dataset of other relevant factors comprising at least one of a copper ore price, an iron ore price, a nickel ore price, a national consumer index, a national producer index, a copper product consumer index, and corresponding time; and integrating the dataset of historical copper price and the dataset of other relevant factors into the raw dataset on a monthly basis; data preprocessing, including: performing a linear transformation on the raw dataset using a linear normalization manner, mapping data in the raw dataset to a range of [0, 1] respectively; and performing data enhancement on factors in the normalized raw dataset using a linear interpolation manner, and performing time interpolation on each of the normalized data using the linear interpolation manner to obtain a multi-factor dataset T on a daily basis; wherein the multi-factor dataset T includes at least one of a historical copper price factor, a copper ore price factor, an iron ore price factor, a nickel ore price factor, a national consumer index factor, a national producer index factor, a copper product consumer index factor, and the corresponding time; generating a data correlation matrix, including: calculating Kendall's correlation coefficient in the multi-factor dataset T to obtain the data correlation matrix; constructing a time-series prediction model; predicting the copper price, including: inputting the multi-factor dataset T into the time-series prediction model to obtain copper price prediction data; constructing a production plan mathematical model and importing the copper price prediction data as parameters into the production plan mathematical model; and obtaining a copper mine production plan by solving the production plan mathematical model using an ant colony algorithm.

One or more embodiments of the present disclosure provide a system for optimizing an open-pit mine production plan based on time-series prediction of copper price. The system may comprise: at least one storage device storing a set of instructions; and at least one processor configured to communicate with the at least one storage device. When executing the set of instructions, the at least one processor may be directed to cause the system to perform operations comprising: obtaining a raw dataset, including: obtaining a dataset of historical copper price and a dataset of other relevant factors correlating with the copper price, the dataset of other relevant factors comprising at least one of a copper ore price, an iron ore price, a nickel ore price, a national consumer index, a national producer index, a copper product consumer index, and corresponding time; and integrating the dataset of historical copper price and the dataset of other relevant factors into the raw dataset on a monthly basis; data preprocessing, including: performing a linear transformation on the raw dataset using a linear normalization manner, mapping data in the raw dataset to a range of [0,1] respectively; and performing data enhancement on factors in the normalized raw dataset using a linear interpolation manner, and performing time interpolation on each of the normalized data using the linear interpolation manner to obtain a multi-factor dataset T on a daily basis; wherein the multi-factor dataset T includes at least one of a historical copper price factor, a copper ore price factor, an iron ore price factor, a nickel ore price factor, a national consumer index factor, a national producer index factor, a copper product consumer index factor, and the corresponding time; generating a data correlation matrix, including: calculating Kendall's correlation coefficient in the multi-factor dataset T to obtain the data correlation matrix; constructing a time-series prediction model; predicting the copper price, including: inputting the multi-factor dataset T into the time-series prediction model to obtain copper price prediction data; constructing a production plan mathematical model and importing the copper price prediction data as parameters into the production plan mathematical model; and obtaining a copper mine production plan by solving the production plan mathematical model using an ant colony algorithm.

One or more embodiments of the present disclosure provide a device for optimizing an open-pit mine production plan based on time-series prediction of copper price. The device may comprise a processor. The processor may be configured to execute the method for optimizing the open-pit mine production plan based on time-series prediction of copper price.

One or more embodiments of the present disclosure provide a non-transitory computer-readable storage medium. The storage medium may store a set of computer instructions, and when reading the set of computer instructions in the storage medium, a computer may execute the method for optimizing the open-pit mine production plan based on time-series prediction of copper price.

### BRIEF DESCRIPTION OF THE DRAWINGS

The present disclosure is further illustrated by way of exemplary embodiments, which is described in detail by means of the accompanying drawings. These embodiments are not limiting, and in these embodiments, the same numbering denotes the same structure, wherein:

FIG. 1 is a schematic diagram illustrating some operations of a method for optimizing an open-pit mine production plan based on time-series prediction of copper price according to some embodiments of the present disclosure;

FIG. 2 is a schematic diagram illustrating a process of obtaining a copper mine production plan by solving a production plan mathematical model using an ant colony algorithm according to some embodiments of the present disclosure; and

FIG. 3 is a schematic diagram of a correlation matrix according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. The present disclosure may be applied to other similar scenarios based on these drawings without creative labor. Unless obviously obtained from the context or the context illustrates otherwise, the same numeral in the drawings refers to the same structure or operation.

It should be understood that the terms “system”, “device” as used herein, “unit” and/or “module” as used herein are a way to distinguish between different components, elements, parts, sections, or assemblies at different levels. However, said words may be replaced by other expressions if other words accomplish the same purpose.

As shown in the disclosure and the claims, unless the context clearly suggests an exception, the words “a”, “an”, and/or “the” do not refer specifically to the singular, but may also include the plural. Generally, the terms “including” and “comprising” suggest only the inclusion of clearly identified steps and elements. In general, the terms “including” and “comprising” only suggest the inclusion of explicitly identified steps and elements that do not constitute an exclusive list, and the method or apparatus may also include other steps or elements.

Flowcharts are used in the present disclosure to illustrate operations performed by a system in accordance with embodiments of the present disclosure. It should be appreciated that the preceding or following operations are not necessarily performed in an exact sequence. Instead, steps may be processed in reverse order or simultaneously. Also, it is possible to add other operations to these processes or to remove a step or steps from these processes.

In some embodiments, a generation plan may be determined for the next quarter by collecting historical monthly copper price and then comparing the price indices, then a predicted copper price may be obtained by adjusting the adjusted value of the predicted copper price of the copper mine. This process makes the prediction results limited by the decomposition effect and ignores the interactions between the components in the long-term future. In addition, it makes the attention mechanism difficult to find reliable time-series dependencies in a long series of complex temporal patterns.

Some embodiments of the present disclosure provide a method for optimizing the open-pit mine production plan based on the time-series prediction of copper price, which may effectively improve the accuracy of copper price prediction through focusing on the correlation between different factors in a multi-factor dataset including historical price information, and obtain a more accurate solution more in line with the actual production situation.

In some embodiments, a system for optimizing an open-pit mine production plan based on time-series prediction of copper price may include at least one processor, a storage medium, and a network.

The at least one processor may include various devices with computing capabilities, such as a CPU or a server. In some embodiments, the server may be an independent server or a server group, which may be centralized or distributed. In some embodiments, the server may be regional or remote. In some embodiments, the server may execute on a cloud platform.

The network may be used to connect the components of the system, allowing communication among the components. The network between various parts of the system may include a wired network and/or a wireless network. For example, the network may include a cable network, a wired network, a fiber optic network, etc., or any combination thereof. The processor may store the constructed time-series prediction model in the storage medium via the network. The network may also be used to obtain data, such as copper ore price, iron ore price, nickel ore price, a national consumer index, a national producer index, a consumer index for copper products, etc. In some embodiments, the network may store the obtained data temporarily in the storage medium for easy access by at least one processor.

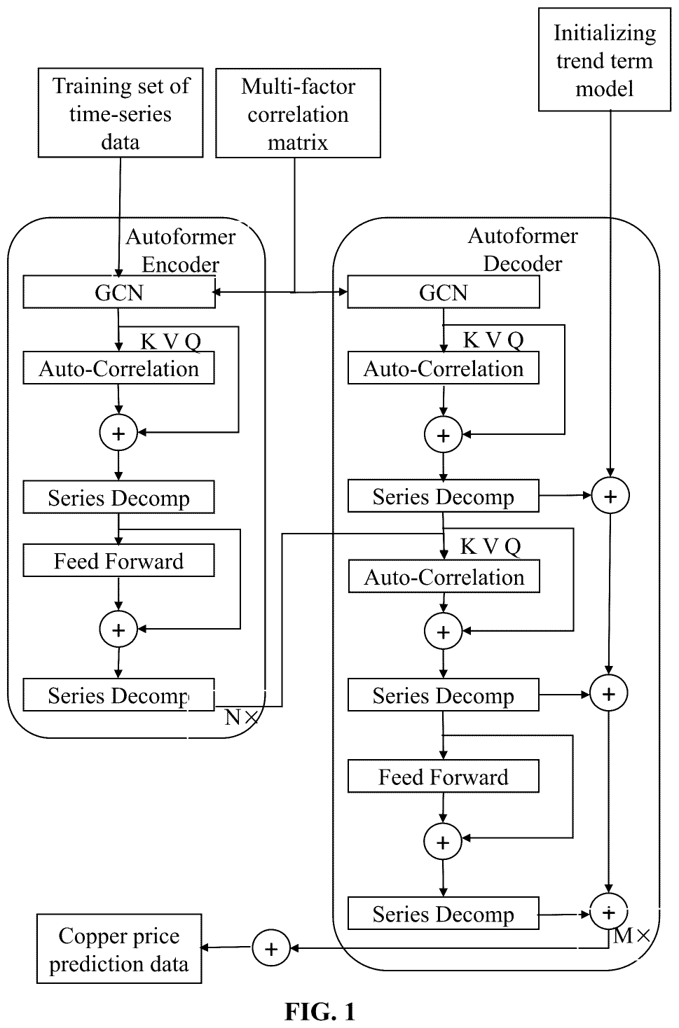

Referring to FIG. 1, FIG. 1 is a schematic diagram illustrating some operations of a method for optimizing an open-pit mine production plan based on a time-series prediction of copper price according to some embodiments of the present disclosure. The method may include one or more operations as follows, which may be executed by a processor.

Operation 1, obtaining a raw dataset: obtaining a dataset of historical copper price and a dataset of other relevant factors correlating with the copper price, the dataset of other relevant factors comprising at least one of a copper ore price, an iron ore price, a nickel ore price, a national consumer index, a national producer index, a copper product consumer index, and corresponding time; and integrating the dataset of historical copper price and the dataset of other relevant factors into the raw dataset on a monthly basis.

In some embodiments, data such as copper ore price, iron ore price, nickel ore price, national consumer index, national producer index, copper product consumer index, etc. may be obtained through external websites (e.g., the First Copper Network, the National Bureau of Statistics, the National Industry Information, the National Foreign Exchange Trading Center, etc.) or manually entered by the user. Because the data about copper ore price, iron ore price, nickel ore price, national consumer index, national producer index, and copper product consumer index are usually published every month, the dataset of historical copper price and dataset of other relevant factors may be integrated into the raw dataset on a monthly basis.

Operation 2, data preprocessing: performing a linear transformation on the raw dataset using a linear normalization manner, mapping data in the raw dataset to a range of [0, 1] respectively; and performing data enhancement on factors in the normalized raw dataset using a linear interpolation manner, and performing time interpolation on each of the normalized data using the linear interpolation manner to obtain a multi-factor dataset T on a daily basis; wherein the multi-factor dataset T includes at least one of a historical copper price factor, a copper ore price factor, an iron ore price factor, a nickel ore price factor, a national consumer index factor, a national producer index factor, a copper product consumer index factor, and the corresponding timc.

In some embodiments, in order to facilitate the subsequent input into the Graph Convolutional Network (GCN) model for calculation, the linear transformation may be performed on the raw dataset so that the values in the raw dataset are all within a range of [0, 1]. For example, if the copper ore price in January is 50,000 yuan/ton, the copper ore price in January may be converted to a value within the range of [0, 1] by the linear transformation, when the copper ore price is at the historical high level, the greater the converted value.

In some embodiments, since the raw dataset is obtained on a monthly basis, in order to make the changes of the various data in the raw dataset smooth, the data in the raw dataset may be enhanced by linear interpolation to obtain the multi-factor dataset T on a daily basis to enrich the influence of each factor on copper price.

Operation 3, generating a data correlation matrix: calculating Kendall's correlation coefficient in the multi-factor dataset T to obtain the data correlation matrix.

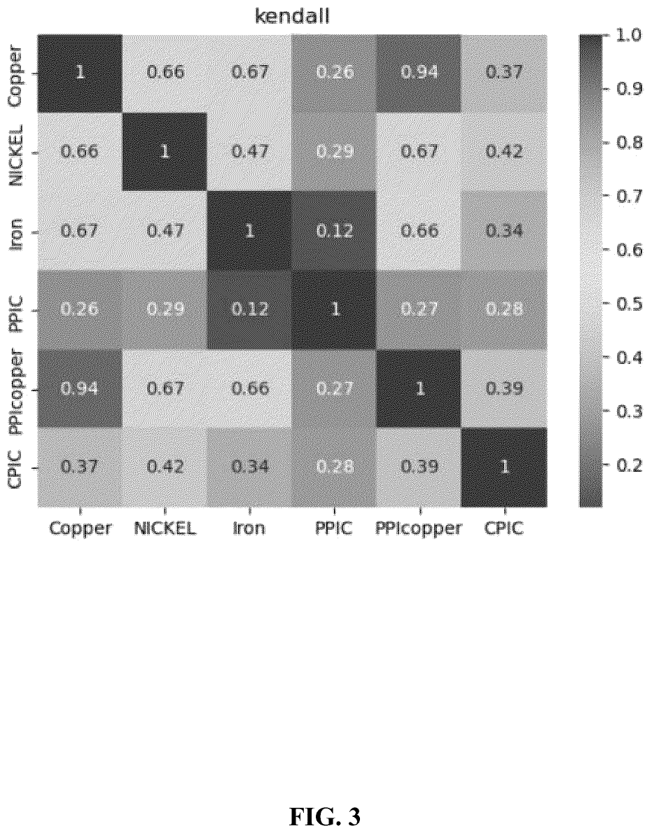

In some embodiments, elements in the data correlation matrix may be Kendall's correlation coefficients; the Kendall's correlation coefficients may be obtained by calculating any two factors using a Tau-b formula to indicate a correlation between two factors; wherein the Kendall's correlation coefficients are within a range of [0, 1], and the data correlation matrix is a square matrix of n−1, where n is the number of factors in the multi-factor dataset T. Calculation of Kendall's correlation coefficients and the Tau-b formula are conventional means, which are not repeated here. The data correlation matrix may be shown in FIG. 3, rows and columns of which may correspond to factors in the multi-factor dataset T, respectively. The elements in the matrix indicate the correlation between the two factors, for example, the coefficient of 0.66 in the first column and the second row in FIG. 3 indicates the correlation between the nickel ore price factor and the copper ore price factor.

Operation 4, constructing a time-series prediction model, comprising following operations.

Operation 4.1, obtaining a focused multi-factor dataset T by focusing the data correlation matrix using a GCN model, and inputting the focused multi-factor dataset to an encoder; the encoder and a decoder corresponding to autocorrelation mechanism.

The input of the GCN model is a multi-factor dataset T, and the output is a focused multi-factor dataset T. The focused multi-factor dataset T contains weights corresponding to the correlations, and the weights may reflect the importance of each correlation. The GCN model may be obtained by training, which is not limited in the present disclosure.

In some embodiments, the encoder and decoder may correspond to an Autoformer autocorrelation mechanism, more description about the Autoformer autocorrelation mechanism may be found in a later related section.

Operation 4.2, performing a first autocorrelation operation on data in the focused multi-factor dataset T, wherein the first autocorrelation operation comprises calculating by using the Kendall's correlation coefficient within a range of [0, 1] in the data correlation matrix as a weight. The autocorrelation operation is common in the autocorrelation mechanism, which is not be repeated here.

Operation 4.3, obtaining a first trend term sequence and a seasonal term sequence by performing a first sequence decomposition on a plurality of factors in the multi-factor dataset T, respectively, and assigning the first trend term sequence to an initialized trend term model.

In some embodiments, the first trend term sequence may be a trend portion of the factors in the multi-factor dataset T that remains constant overall over time, and the seasonal term sequence may be a fluctuating portion of the factors in the multi-factor dataset T that keeps recurring over a certain period. The sequence decomposition is the decomposition of the two changing modes (i.e., the trend portion and the periodic fluctuating portion) coexisting in a time-series data and processing separately. Sequence decomposition for long time-series prediction (e.g., multi-factor dataset T) is common, which is not be repeated here. The trend term model is a mathematical model in the autocorrelation mechanism, which may be used to obtain the situation reflecting the trend term in long time-series.

Operation 4.4, inputting the seasonal term sequence output by a feedforward module in the encoder into the decoder and performing a second autocorrelation operation in the decoder, and performing a second sequence decomposition to obtain a second trend term sequence, and assigning the second trend term sequence to the trend term model in the operation 4.3. Similar to the first sequence decomposition and the first autocorrelation, the second sequence decomposition and the second autocorrelation operation are also common.

Operation 4.5, outputting data from a feedforward module in the decoder, and performing a third sequence decomposition of the output data from the feedforward module in the decoder, and adding an independent trend term sequence to the seasonal term sequence to obtain the copper price prediction data; wherein the independent trend term sequence is the trend term model.

The input of the time-series prediction model constructed in operation 4 is a multi-factor dataset T, and the output of the time-series prediction model is copper price prediction data. The copper price prediction data may include predicted values of copper price on a daily basis over a certain period of time.

Operation 5, predicting the copper price: inputting the multi-factor dataset T into the time-series prediction model generated in operation 4 to obtain the copper price prediction data.

Operation 6, constructing a production plan mathematical model considering copper price and importing the copper price prediction data as parameters into the production plan mathematical model.

In some embodiments, the production plan mathematical model may be an existing copper mine production plan mathematical model, more description of the production plan mathematical model may be found in a later related description.

Operation 7, obtaining a copper mine production plan by solving the production plan mathematical model using an ant colony algorithm.

In some embodiments, the copper mine production plan may be obtained by solving the production plan mathematical model using a conventional ant colony algorithm. In some embodiments, the copper mine production plan may be a schedule for mining a particular block area during a certain period of time provided based on a block model of the copper mining area. The schedule may include production plans in annual, monthly, daily, and other cycles. In some embodiments, the copper mine production plan may include a mining location and a mining amount of a corresponding date, etc.

The present disclosure provides a method for optimizing the production plan of an open-pit mine based on the time series prediction of the copper price, which may provide a production plan with higher accuracy and guidance using a time-series prediction model.

In some embodiments, the autocorrelation mechanism of the encoder may be the series-wise connection autocorrelation mechanism in the Autoformer mechanism, and the series-wise connection autocorrelation mechanism enables the discovery of dependencies from cycles and breaks information utilization bottlenecks. The series-wise connection autocorrelation mechanism includes at least Period-based dependencies and Time delay aggregation. Series-level efficient connectivity is achieved through Period-based dependencies and Time delay aggregation, which allows for better information aggregation to predict copper price over further time.

In some embodiments, operation 6 may include one or more of the following operations.

The production plan mathematical model with consideration of copper price is imported into the max-min ant colony algorithm, a maximum profit function considering copper price fluctuation and constraints that need to be solved are set, and a block model, an economic parameter, and a process parameters of the max-min ant colony algorithm are set. The maximum profit function considering copper price fluctuation and the constraints may be selected and input based on the actual situation of the mining area.

The max-min ant colony algorithm is an optimization algorithm that combines the fundamentals of the ant colony algorithm, and sets upper and lower limits for the pheromone concentration on each path to avoid a significant difference in pheromone concentration, which may lead to the algorithm quickly converging to a locally optimal solution and miss the more optimal solution. The block model, the economic parameters, and the process parameters of the max-min ant colony algorithm may be set according to the actual situation based on the mining area. Based on the block model, the mining area may be divided into multiple blocks.

Exemplarily, taking the process parameters as an example, the process parameters may include a cost incurred by the mining equipment transporting a specified weight of ore in the mining area, a processing cost incurred when processing a unit weight of ore, or the like. The process parameters may be different in different mining areas as well as in the use of different mining process, which is not limited.

In some embodiments, a process of constructing a production plan mathematical model considering copper price may include one or more following operations.

Operation 6.1, establishing a formula for maximizing a total profit derived from mining at an objective of the production plan:

$$Maximize {\sum }_{b ∈ B} {\sum }_{t ∈ T} ( {g}_{b} {c}_{t} - {v}_{t} ) {x}_{bt} \qquad ( 1 )$$

where B is a set of all block numbers, g_{b} is a copper content of block b, wherein the copper content is obtained based on a weight of the block b and a copper grade, the weight of the block and the copper grade are estimated from the drilling data obtained from the early exploration work in the mining area, cₜ is the copper price during a period t and cₜ∈C, C is a set of the copper price prediction data, T is a set of the period t, vₜ is a mining cost during the period t considering a cash discount rate, x_{bt} denotes whether the block b is mined during the period t, and x_{bt} is a variable between 0 and 1.

Operation 6.2, determining mining priority geometry constraints:

$${x}_{bt} \leq {\sum }_{t ∈ T} {x}_{{b}^{′} t} ∀ b ∈ B , {b}^{′} ∈ {B}_{b} , t ∈ T \qquad ( 2 )$$

where B_{b} is a set of antecedent block numbers of the block b, and b′ is the antecedent block of the block b. The formula (2) indicates that before mining block b, the antecedent block may be mined first. The antecedent blocks mean that before mining a certain block (such as block b), due to the limitation of mining safety slope or direct spatial constraints, specific blocks need to be mined first to continue mining other blocks (such as block b). The formula (2) is used to represent the spatial relationship limitations between blocks in actual production.

$${\sum }_{t ∈ τ} {x}_{bt} \leq 1 ∀ t ∈ T \qquad ( 3 )$$

The formula (3) indicates that block b is only be mined for one period or never mined.

Operation 6.3, determining resource capacity constraints:

$${\underline{R}}_{{}^{rt}} \leq {\sum }_{b ∈ B} {q}_{br} {x}_{bt} \leq {\overline{R}}_{rt} ∀ t ∈ T , r ∈ R \qquad ( 4 )$$

$${x}_{bt} ∈ \{ 0 , 1 \} ∀ b ∈ B , t ∈ T \qquad ( 5 )$$

where R is a set of operable resource r, q_{br} is an amount of the resource r consumed by mining the block b, R̅ᵣₜ is a maximum limit on the amount of available resource r during the period t, and Rᵣₜ is a minimum limit on the amount of available resource r during the period t. In some embodiments, operable resources may be inputted based on the actual situation of the mine, such as the maximum allowable support of the mine per unit time in blasting, transportation, processing, and other processes.

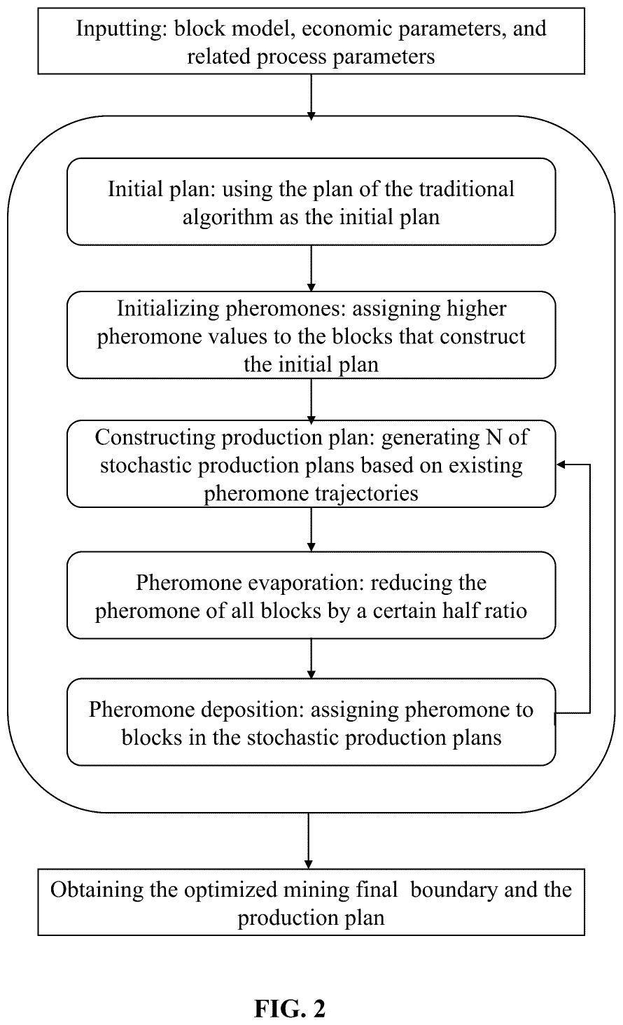

FIG. 2 is a schematic diagram illustrating a process of obtaining a copper mine production plan by solving a production plan mathematical model using an ant colony algorithm according to some embodiments of the present disclosure. Referring to FIG. 2, in some embodiments, operation 7 may include one or more following operations.

Operation 7.1, determining an initial plan. In some embodiments, a plan of the conventional algorithm may be used as the initial plan, and the plan of the conventional algorithm may be a scheme determined based on the Lerchs-Grossmann Graph Theory Method (LGGTM) or other plans, which is not limited.

Operation 7.2, initializing the pheromone, assigning higher pheromone values to the blocks that construct the initial plan. The pheromone is a core idea in the max-min ant colony algorithm, which may be found in the previous related description.

In some embodiments, one or more rounds of iterations may be performed on the initialized pheromone based on the max-min ant colony algorithm, and any one of the rounds of iterations includes follow operations.

Operation 7.3, constructing a production plan: generating a plurality of stochastic production plans based on existing pheromone trajectories.

Operation 7.4, evaporating the pheromones: reducing the pheromone values of all blocks.

Operation 7.5, depositing the pheromones: assigning new pheromone values to blocks in the stochastic production plans, and returning operation 7.3 and proceeding to a next round of iterations in response to that a maximum number of iterations is not reached; and performing operation 7.6 in response to the maximum number of iterations is reached.

Operation 7.6, obtaining an optimized mining final boundary and an optimized production plan. The final boundary refers to a state of the mine at which the mining process is completed or the mining time has reached its maximum age. Based on the final boundary combined with the total profit obtained from maximizing mining in operation 6, a production plan that maximizes profits may be obtained.

Some embodiments of the present disclosure further provide a method for optimizing the open-pit mine production plan based on time-series prediction of copper price, which is performed by the following operations.

Operation 1, generating a raw dataset: obtaining a dataset of historical copper price and a dataset of other relevant factors correlating with the copper price, and integrating the dataset of historical copper price and the dataset of other relevant factors into the raw dataset on a monthly basis.

Operation 2, data preprocessing: performing a linear transformation on the obtained raw dataset in the operation 1 using a linear normalization manner, and mapping data in the raw dataset to a range of [0, 1] respectively to realize the unification of multiple data dimensions in the dataset; and performing data enhancement on factors in the normalized raw dataset, and performing time interpolation on each of the normalized data using the linear interpolation manner to obtain a multi-factor dataset T on a daily basis; wherein the multi-factor dataset T includes at least one of a historical copper price factor, a copper ore price factor, an iron ore price factor, a nickel ore price factor, a national consumer index factor, a national producer index factor, a copper product consumer index factor, and the corresponding time.

Operation 3, generating a data correlation matrix: calculating Kendall's correlation coefficient in the obtained multi-factor dataset T in the operation 2 to obtain the data correlation matrix; wherein the Kendall's correlation coefficient is calculated using the Tau-b formula to quantitatively represent the correlation between two factors, the obtained correlation coefficients range from [0, 1]; and constructing the data correlation matrix with (n−1)×(n−1) based on the correlation coefficients between the factor and other different factors, where n is the number of factors in the multi-factor dataset T.

Operation 4, constructing a time-series prediction model.

Operation 4.1, focusing correlation of different weights of the multi-factor dataset T in the obtained data correlation matrix in operation 3 using a GCN model, and inputting the focused multi-factor dataset to an encoder.

Operation 4.2, performing a first autocorrelation operation on data in the multi-factor dataset T, and calculating by using the correlation coefficient within a range of [0, 1] in the data correlation matrix as a weight.

Operation 4.3, obtaining a first trend term sequence and a seasonal term sequence by performing a first sequence decomposition on a plurality of factors in the multi-factor dataset T, respectively using a sequence decomposition module, and assigning the first trend term sequence to an initialized trend term model; wherein the first trend sequence refers to the overall trend that maintains over time, while the seasonal sequence refers to the fluctuating parts that repeatedly appear over a certain period of time; and the sequence decomposition is the process of decomposing two changing modes coexisting in a time-series data and considering them separately.

Operation 4.4, inputting the seasonal term sequence output by a feedforward module in the encoder into the decoder and performing a second autocorrelation operation in the decoder, and performing a second sequence decomposition to obtain a second trend term sequence, and assigning the second trend term sequence to the trend term model in operation 4.3.

Operation 4.5, outputting data from a feedforward module in the decoder, and performing a third sequence decomposition of the output data from the feedforward module in the decoder, and adding an independent trend term sequence to the seasonal term sequence to obtain the final copper price prediction data; wherein the seasonal term sequence is the seasonal term in the operation 4.3, and the independent trend term sequence is trend term independent of the seasonal term, i.e., the trend term model.

Operation 5, predicting the copper price: inputting the multi-factor dataset T into the generated time-series prediction model in operation 4 to generate predicted copper price dataset.

Operation 6, constructing a production plan mathematical model considering the copper price: importing the variable copper price as parameters into the production plan mathematical model.

Operation 7, determining the production plan using an ant colony algorithm: generating an optimized production plan by solving the production plan mathematical model using the ant colony algorithm.

Beneficial effects of some embodiments of the present specification include, but are not limited to as follows.
(1) This technical solution optimizes the existing model, introduces the GCN model into the autocorrelation mechanism, takes advantage of the GCN model being able to focus the correlation between the factors, gives play to the excellent performance of the Autoformer mechanism for the prediction of multi-factor datasets, and gradually separates the trend term and the periodic term from the hidden variables in the prediction process using the series-wise connected autocorrelation mechanism, which realizes progressive decomposition, so this method can alternately optimize the prediction results and perform sequence decomposition, which may realize the mutual promotion, the focus of the correlation of different factors in the multi-factor dataset, and effectively improve the accuracy of the prediction of copper price.
(2) For the optimization problem of the open-pit mine production plan, this method innovates on the original mathematical model, establishes the formula of maximizing the total profit derived from mining at the object of the production plan, and solves using the max-min ant colony algorithm, and predicts experimental results based on the time-series prediction of the price of copper, substitutes the copper price as parameters changing over time into the open-pit mine production plan. The obtained optimized production plan yields a higher net profit compared to the conventional model and is also closer to the expected net profit than the conventional model.

The basic concepts have been described above, and it is apparent to those skilled in the art that the foregoing detailed disclosure is intended as an example only and does not constitute a limitation of the present disclosure. While not expressly stated herein, various modifications, improvements, and amendments may be made to the present disclosure by those skilled in the art. Those types of modifications, improvements, and amendments are suggested in the present disclosure, so those types of modifications, improvements, and amendments remain within the spirit and scope of the exemplary embodiments of the present disclosure.

Also, the specification uses specific words to describe embodiments of the disclosure. such as “one embodiment”, “an embodiment”, and/or “some embodiment” mean a feature, structure, or characteristic associated with at least one embodiment of the present disclosure. Accordingly, it should be emphasized and noted that “one embodiment” or “an embodiment” or “an alternative embodiment” in different places in the present disclosure do not necessarily refer to the same embodiment. In addition, certain features, structures, or characteristics in one or more embodiments of the present specification may be suitably combined.

Furthermore, unless expressly stated in the claims, the order of the processing elements and sequences, the use of numerical letters, or the use of other names as described in the present disclosure are not intended to qualify the order of the processes and methods of the present disclosure. While some embodiments of the disclosure that are currently considered useful are discussed in the foregoing disclosure by way of various examples, it should be appreciated that such details serve only illustrative purposes, and that additional claims are not limited to the disclosed embodiments, rather, the claims are intended to cover all amendments and equivalent combinations that are consistent with the substance and scope of the embodiments of the present disclosure. For example, although the implementation of various components described above may be embodied in a hardware device, it may also be implemented as a software-only solution, e.g., an installation on an existing server or mobile device.

Similarly, it should be noted that to simplify the presentation of the disclosure, and aid in the understanding of one or more embodiments of the disclosure, the foregoing descriptions of embodiments of the disclosure sometimes combine a variety of features into a single embodiment, accompanying drawings, or descriptions thereof. description thereof. However, this method of disclosure does not imply that the objects of the present disclosure require more features than those mentioned in the claims. Rather, claimed subject matter may lie in less than all features of a single foregoing disclosed embodiment.

Some embodiments use numbers describing the number of components, attributes, and it should be understood that such numbers used in the description of embodiments are modified in some examples by the modifiers “approximately”, “nearly”, or “substantially”, or “generally” is used in some examples. Unless otherwise noted, the terms “about,” “approximately,” or “approximately” indicate that a ±20% variation in the stated number is allowed. Correspondingly, in some embodiments, the numerical parameters used in the disclosure and claims are approximations, which may change depending on the desired characteristics of the individual embodiment. In some embodiments, the numerical parameters should take into account the specified number of valid digits and employ general place-keeping. While the numerical domains and parameters used to confirm the breadth of their ranges in some embodiments of the present disclosure are approximations, in specific embodiments such values are set to be as precise as possible within a feasible range.

For each patent, patent application, patent application disclosure, and other material cited in the present disclosure, such as articles, books, manuals, publications, documents, etc., the entire contents of which are hereby incorporated herein by reference. Application history documents that are inconsistent with or conflict with the contents of the present disclosure are excluded, as are documents (currently or hereafter appended to the present disclosure) that limit the broadest scope of the claims of the present disclosure. It should be noted that to the extent that there is an inconsistency or conflict between the descriptions, definitions, and/or use of terms in the materials appurtenant to the present disclosure and those set forth herein, the descriptions, definitions and/or use of terms in the present disclosure shall control. use shall prevail.

Finally, it should be understood that the embodiments described in the present disclosure are only used to illustrate the principles of the embodiments of the present disclosure. Other deformations may also fall within the scope of the present disclosure. As such, alternative configurations of embodiments of the present specification may be viewed as consistent with the teachings of the present specification as an example, not as a limitation. Correspondingly, the embodiments of the present specification are not limited to the embodiments expressly presented and described herein.

What is claimed is:

1. A method for optimizing an open-pit mine production plan based on time-series prediction of copper price, executed by a processor, the method comprising:
obtaining a raw dataset, including: obtaining a dataset of historical copper price and a dataset of other relevant factors correlating with the copper price, the dataset of other relevant factors comprising at least one of a copper ore price, an iron ore price, a nickel ore price, a national consumer index, a national producer index, a copper product consumer index, and corresponding time; and integrating the dataset of historical copper price and the dataset of other relevant factors into the raw dataset on a monthly basis;
data preprocessing, including: performing a linear transformation on the raw dataset using a linear normalization manner, mapping data in the raw dataset to a range of [0, 1] respectively; and performing data enhancement on factors in the normalized raw dataset using a linear interpolation manner, and performing time interpolation on each of the normalized data using the linear interpolation manner to obtain a multi-factor dataset T on a daily basis; wherein the multi-factor dataset T includes at least one of a historical copper price factor, a copper ore price factor, an iron ore price factor, a nickel ore price factor, a national consumer index factor, a national producer index factor, a copper product consumer index factor, and the corresponding time;
generating a data correlation matrix, including: calculating Kendall's correlation coefficient in the multi-factor dataset T to obtain the data correlation matrix;
constructing a time-series prediction model;
predicting the copper price, including: inputting the multi-factor dataset T into the time-series prediction model to obtain copper price prediction data;
constructing a production plan mathematical model and importing the copper price prediction data as parameters into the production plan mathematical model; and
obtaining a copper mine production plan by solving the production plan mathematical model using an ant colony algorithm.

2. The method according to claim 1, wherein the constructing a time-series prediction model comprises:
obtaining a focused multi-factor dataset T by focusing the data correlation matrix using a Graph Convolutional Network (GCN) model, and inputting the focused multi-factor dataset to an encoder; the encoder and a decoder corresponding to autocorrelation mechanism;
performing a first autocorrelation operation on data in the focused multi-factor dataset T, wherein the first autocorrelation operation comprises calculating by using the Kendall's correlation coefficient within a range of [0, 1] in the data correlation matrix as a weight;
obtaining a first trend term sequence and a seasonal term sequence by performing a first sequence decomposition on a plurality of factors in the multi-factor dataset T, respectively, and assigning the first trend term sequence to an initialized trend term model;
inputting the seasonal term sequence output by a feedforward module in the encoder into the decoder and performing a second autocorrelation operation in the decoder, and performing a second sequence decomposition to obtain a second trend term sequence, and assigning the second trend term sequence to the trend term model; and
outputting data from a feedforward module in the decoder, and performing a third sequence decomposition of the output data from the feedforward module in the decoder, and adding an independent trend term sequence to the seasonal term sequence to obtain the copper price prediction data; wherein the independent trend term sequence is the trend term model.

3. The method according to claim 2, wherein the autocorrelation mechanism of the encoder is a series-wise connection autocorrelation mechanism, wherein the series-wise connection autocorrelation mechanism comprises at least period-based dependencies and time delay aggregation.

4. The method according to claim 1, wherein the constructing a production plan mathematical model and importing the copper price prediction data as parameters into the production plan mathematical model comprises:
importing the production plan mathematical model into a max-min ant colony algorithm, setting a maximum profit function considering copper price fluctuation and constraints that need to be solved, and setting a block model, an economic parameter, and process parameters of the max-min ant colony algorithm.

5. The method according to claim 4, wherein the constructing the production plan mathematical model comprises:
establishing a formula for maximizing a total profit derived from mining at an objective of the production plan:
$$Maximize {{\sum }_{b ∈ B}}_{} {{\sum }_{t ∈ T}}_{} ( {g}_{b} {c}_{t} - {v}_{t} ) {x}_{bt}$$
where B is a set of all block numbers, g_{b} is a copper content of block b, wherein the copper content is obtained based on a weight of the block b and a copper grade, cₜ is the copper price during a period t and cₜ∈C, C is a set of the copper price prediction data, T is a set of the period t, vₜ is a mining cost during the period t considering a cash discount rate, x_{bt} denotes whether the block b is mined during the period t, and x_{bt} is a variable between 0 and 1;
determining mining priority geometry constraints:
$${x}_{bt} \leq {\sum }_{t ∈ T} {x}_{{b}^{′} t} ∀ b ∈ B , {b}^{′} ∈ {B}_{b} , t ∈ T$$
where B_{b} is a set of antecedent block numbers of the block b, and b′ is the antecedent block of the block b;
$${\sum }_{t ∈ T} {x}_{bt} \leq 1 ∀ t ∈ T$$
determining resource capacity constraints:
$${\underline{R}}_{{}^{rt}} \leq {{\sum }_{b ∈ B}}_{} {q}_{br} {x}_{bt} \leq {\overline{R}}_{rt} ∀ t ∈ T , r ∈ R \\ {x}_{bt} ∈ \{ 0 , 1 \} ∀ b ∈ B , t ∈ T$$
where R is a set of operable resource r, q_{br} is an amount of the resource r consumed by mining the block b, R̅ᵣₜ is a maximum limit on the amount of available resource r during the period t, and Rᵣₜ is a minimum limit on the amount of available resource r during the period t.

6. The method according to claim 5, wherein the obtaining a copper mine production plan by solving the production plan mathematical model using an ant colony algorithm comprises:
determining an initial plan;
initializing pheromones, and assigning higher pheromone values to blocks that construct the initial plan;
performing one or more rounds of iterations, wherein any one of which includes:
constructing a production plan, including: generating a plurality of stochastic production plans based on existing pheromone trajectories;
evaporating the pheromones, including: reducing the pheromone values of all blocks; and
depositing the pheromones, including: assigning new pheromone values to blocks in the stochastic production plans, and proceeding to a next round of iterations in response to that a maximum number of iterations is not reached; and
obtaining an optimized mining final boundary and an optimized production plan.

7. A system for optimizing an open-pit mine production plan based on time-series prediction of copper price, comprising: at least one storage device storing a set of instructions; and
at least one processor configured to communicate with the at least one storage device, wherein when executing the set of instructions, the at least one processor is directed to cause the system to perform operations comprising:
obtaining a raw dataset, including: obtaining a dataset of historical copper price and a dataset of other relevant factors correlating with the copper price, the dataset of other relevant factors comprising at least one of a copper ore price, an iron ore price, a nickel ore price, a national consumer index, a national producer index, a copper product consumer index, and corresponding time; and integrating the dataset of historical copper price and the dataset of other relevant factors into the raw dataset on a monthly basis;
data preprocessing, including: performing a linear transformation on the raw dataset using a linear normalization manner, mapping data in the raw dataset to a range of [0,1] respectively; and performing data enhancement on factors in the normalized raw dataset using a linear interpolation manner, and performing time interpolation on each of the normalized data using the linear interpolation manner to obtain a multi-factor dataset T on a daily basis; wherein the multi-factor dataset T includes at least one of a historical copper price factor, a copper ore price factor, an iron ore price factor, a nickel ore price factor, a national consumer index factor, a national producer index factor, a copper product consumer index factor, and the corresponding time;
generating a data correlation matrix, including: calculating Kendall's correlation coefficient in the multi-factor dataset T to obtain the data correlation matrix;
constructing a time-series prediction model;
predicting the copper price, including: inputting the multi-factor dataset T into the time-series prediction model to obtain copper price prediction data;
constructing a production plan mathematical model and importing the copper price prediction data as parameters into the production plan mathematical model; and
obtaining a copper mine production plan by solving the production plan mathematical model using an ant colony algorithm.

8. The system according to claim 7, wherein to construct a time-series prediction model, the at least one processor is further directed to cause the system to perform operations comprising:
obtaining a focused multi-factor dataset T by focusing the data correlation matrix using a Graph Convolutional Network (GCN) model, and inputting the focused multi-factor dataset to an encoder; the encoder and a decoder corresponding to autocorrelation mechanism;
performing a first autocorrelation operation on data in the focused multi-factor dataset T, wherein the first autocorrelation operation comprises calculating by using the Kendall's correlation coefficient within a range of [0, 1] in the data correlation matrix as a weight;
obtaining a first trend term sequence and a seasonal term sequence by performing a first sequence decomposition on a plurality of factors in the multi-factor dataset T, respectively, and assigning the first trend term sequence to an initialized trend term model;
inputting the seasonal term sequence output by a feedforward module in the encoder into the decoder and performing a second autocorrelation operation in the decoder, and performing a second sequence decomposition to obtain a second trend term sequence, and assigning the second trend term sequence to the trend term model; and
outputting data from a feedforward module in the decoder, and performing a third sequence decomposition of the output data from the feedforward module in the decoder, and adding an independent trend term sequence to the seasonal term sequence to obtain the copper price prediction data; wherein the independent trend term sequence is the trend term model.

9. The system according to claim 8, wherein the autocorrelation mechanism of the encoder is a series-wise connection autocorrelation mechanism, wherein the series-wise connection autocorrelation mechanism comprises at least period-based dependencies and time delay aggregation.

10. The system according to claim 7, wherein to construct a production plan mathematical model and import the copper price prediction data as parameters into the production plan mathematical model, the at least one processor is further directed to cause the system to perform operations comprising:
importing the production plan mathematical model into a max-min ant colony algorithm, setting a maximum profit function considering copper price fluctuation and constraints that need to be solved, and setting a block model, an economic parameter, and a process parameter of the max-min ant colony algorithm.

11. The system according to claim 10, wherein to construct the production plan mathematical model, the at least one processor is further directed to cause the system to perform operations comprising:
establishing a formula for maximizing a total profit derived from mining at an objective of the production plan:
$$Maximize {{\sum }_{b ∈ B}}_{} {{\sum }_{t ∈ T}}_{} ( {g}_{b} {c}_{t} - {v}_{t} ) {x}_{bt}$$
where B is a set of all block numbers, g_{b} is a copper content of block b, wherein the copper content is obtained based on a weight of the block b and a copper grade, cₜ is the copper price during a period t and cₜ∈C, C is a set of the copper price prediction data, T is a set of the period t, vₜ is a mining cost during the period t considering a cash discount rate, x_{bt} denotes whether the block b is mined during the period t, and x_{bt} is a variable between 0 and 1;
determining mining priority geometry constraints:
$${x}_{bt} \leq {\sum }_{t ∈ T} {x}_{{b}^{′} t} ∀ b ∈ B , {b}^{′} ∈ {B}_{b} , t ∈ T$$
where B_{b} is a set of antecedent block numbers of the block b, and b′ is the antecedent block of the block b;
$${\sum }_{t ∈ T} {x}_{bt} \leq 1 ∀ t ∈ T$$
determining resource capacity constraints:
$${\underline{R}}_{{}^{rt}} \leq {{\sum }_{b ∈ B}}_{} {q}_{br} {x}_{bt} \leq {\overline{R}}_{rt} ∀ t ∈ T , r ∈ R \\ {x}_{bt} ∈ \{ 0 , 1 \} ∀ b ∈ B , t ∈ T$$
where R is a set of operable resource r, q_{br} is an amount of the resource r consumed by mining the block b, R̅ᵣₜ is a maximum limit on the amount of available resource r during the period t, and Rᵣₜ is a minimum limit on the amount of available resource r during the period t.

12. The system according to claim 11, wherein to obtain a copper mine production plan by solving the production plan mathematical model using an ant colony algorithm, the at least one processor is further directed to cause the system to perform operations comprising:
determining an initial plan;
initializing pheromones, and assigning higher pheromone values to blocks that construct the initial plan;
performing one or more rounds of iterations, wherein any one of which includes:
constructing a production plan, including: generating a plurality of stochastic production plans based on existing pheromone trajectories;
evaporating the pheromones, including: reducing the pheromone values of all blocks; and
depositing the pheromones, including: assigning new pheromone values to blocks in the stochastic production plans, and proceeding to a next round of iterations in response to that a maximum number of iterations is not reached; and
obtaining an optimized mining final boundary and an optimized production plan.

13. A device for optimizing an open-pit mine production plan based on time-series prediction of copper price, comprising a processor, the processor being configured to execute the method for optimizing the open-pit mine production plan based on time-series prediction of copper price of claim 1.

14. A non-transitory computer-readable storage medium, the storage medium storing a set of computer instructions, and when reading the set of computer instructions in the storage medium, a computer executes the method for optimizing the open-pit mine production plan based on time-series prediction of copper price of claim 1.
